(19) United States
(12) Patent Application Publication
(10) Pub. No.: US 2026/0293853 A1
(43) Pub. Date: Oct. 1, 2026

(54) MODULAR PET LEASH

(71) Applicant: Moiz Khan, Columbia, MD (US)

(72) Inventor: Moiz Khan, Columbia, MD (US)

(21) Appl. No.: 19/632,821

(22) Filed: Mar. 30, 2026

Related U.S. Application Data
(60) Provisional application No. 63/780,697, filed on Mar. 31, 2025.

(51) Int. Cl. A01K 27/00; H01F 7/02

(52) U.S. Cl. CPC A01K 27/004; A01K 27/008; H01F 7/0252

(57) ABSTRACT

A modular pet leash includes a magnetic attachment and one or more connectors for attaching to various accessories. The leash may be retractable by an internal spool mechanism and provide a lock mechanism for limiting a length of the leash as desired.

### PRIORITY CLAIM

This application claims the benefit and priority of U.S. Provisional Patent Application 63/780,697 filed on Mar. 31, 2025, which is incorporated by reference, herein, in its entirety, with the exception that to the extent that the provisional application conflicts with the present application, the present application is given precedence.

### BACKGROUND

### 1. Technical Field

This disclosure relates generally a modular leash device and system. The modular leash device and system includes connectors for connecting various accessories. The modular leash device and system further implements magnetic attachments for hands free use.

### 2. Description of the Related Art

It is thought that the domestication of animals occurred fairly early on in human history. Early humans desired domesticated animals both for food and for work. For example, dogs and wolves were known to have high intelligence, excellent night vision, fast reflexes, high speed, and defensive abilities that were desirable to humans. Horses and oxen were far stronger than humans and could perform work that would take multiple humans to accomplish. These animals further benefited from man's protection, ability to use tools, reasoning ability, and intelligence. As such, a symbiotic relationship was forged between humans and work animals that benefited both.

Dogs, in particular, are known for their loyalty and their nature to protect their companions, earning them recognition as “man's best friend.” Humans also protected dogs by providing them with shelter and food. Later, various civilizations are known from their art to have used harnesses or restraints to protect dogs and other people. Mesopotamian, Egyptian, and Roman civilizations are known to have used leashes to both control dogs, to protect them from their natural inclination to fight, and to protect other people from aggressive dogs. Leashes were thought to be used to also help train dogs to hunt.

As time went on, some dogs became less specialized in their training and purpose and largely provided their owners with companionship. Companionship dogs frequently become powerfully attached to their owners to the point where some dogs will become aggressive when another person tries to get close to their owners. When dogs are taken out of their normal living areas, and encounter unknown people, many dogs'sense of danger is heightened, which makes them more difficult to control. Depending on the size of the dog, they can be particularly difficult to control.

Various types of harnesses, restraints, and leashes have been developed. Collars were further developed to give a person a simple attachment point for a leash on a dog. As suburbanization has become more ubiquitous across the world, dogs are less able to walk freely, even with their owners. Many cities have approved ordinances that require dogs to be leashed in public spaces and also require that dog owners pick up their dogs'waste. As such, taking a dog for a walk has become significantly more cumbersome. The dog owner must dedicate at least one hand to holding a leash while using another hand to pick up dog waste in many cases, which can be difficult, especially for people who are less mobile and more likely to have a dog for companionship.

It is therefore an object of this disclosure to provide a pet leash that is suitable to attach as a leash to a living being. It is an object of this disclosure to provide a hands-free leash device. It is a further object of this disclosure to provide a leash that uses magnetic attachments. It is a further object of this disclosure to provide a leash that includes connectors for various accessories.

### SUMMARY

Disclosed herein are devices and systems for a pet leash. A pet leash may include a magnetic attachment and one or more connectors for attaching to various accessories. The leash may be retractable by means of an internal spool mechanism and provide a lock mechanism for limiting a length of the leash as desired.

### BRIEF DESCRIPTION OF THE DRAWINGS

The accompanying drawings illustrate various embodiments of pet leash systems and devices.

FIG. 1 illustrates a perspective view of a leash body.

FIG. 2 illustrates a perspective view of a leash body with connected accessories.

FIG. 3 illustrates a side view of a leash body with connected accessories.

FIG. 4 illustrates a rear perspective view of a leash body with connected accessories.

FIG. 5 illustrates a leash system.

### DETAILED DESCRIPTION OF PREFERRED EMBODIMENTS

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

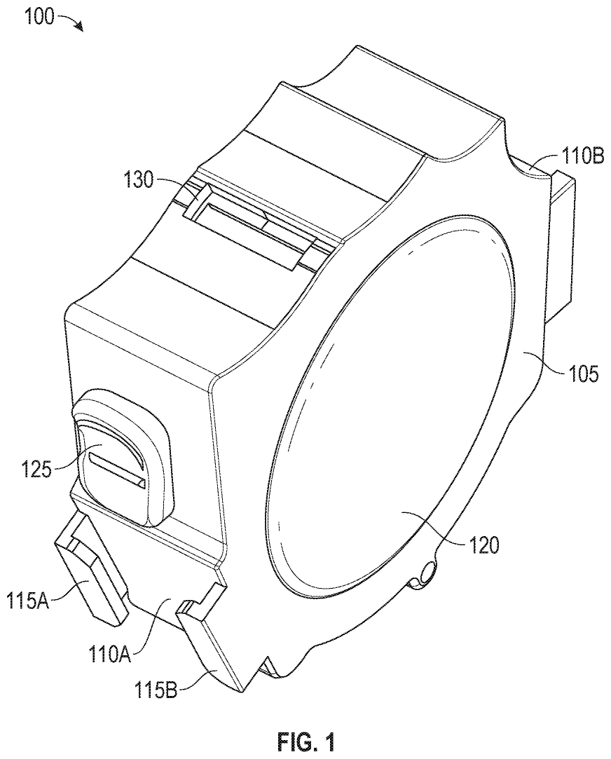

FIG. 1 illustrates a perspective view of a leash body 100. Leash body 100 may include a housing 105 which may be constructed using various materials including metals, metal alloys, and plastics. Housing 105 may include a number of other elements to provide leash body 100. For example, housing 105 includes a connector 110A which may be used to connect various accessories to leash body 100. As shown, connector 110A includes a first connection element 115A and a second connection element 115 which may facilitate connection of housing 105 with an accessory, as will be discussed below. Connector 110A may be formed in a shape that is complimentary to a corresponding connector on an accessory device. In other words, connection element 115A and 115B may interface with corresponding elements of an accessory device to secure a connection between connector 110A and the accessory device. It is noted that housing 105 may include one or more connectors, such as connector 110B which are all implemented similarly to connector 110A. While only two connectors, 110A and 110B, are shown in FIG. 1, it is conceived that one or more connectors may be implemented into housing 105, as desired. The one or more connectors 110A and 110B may be implemented as clips having retainers that interface to effect a secure connection between an accessory and one of one or more connectors 110A and 110B.

Housing 105 may further include a disc 120. Disc 120 may be responsive to magnetic forces (e.g., ferromagnetic, paramagnetic, and diamagnetic) and formed using metals, metal alloys, and other magnetic materials. In one embodiment, disc 120 may be constructed from stainless steel or iron. Disc 120 may have magnetically reactive properties or may itself be implemented as a magnet. Disc 120 may be inserted into a corresponding retainer or molding in housing 105 or may be secured by adhesives such as epoxies and glue. Disc 120 may be installed on a side of housing 105 or both sides of housing 105 to accommodate individuals who are right or left handed, as will be discussed below. It is also noted that disc 120 is shown as being circular, although disc 120 could also be implemented in any geometric shape, such as a triangle, a square, a rectangle, or any other multi-sided shape. The term “disc” in disc 120 is not intended to be limited to meaning a circular shape.

Housing 105 may further include a lock 125 which may be selectively articulated to cause a leash to be locked or released from an internal spool holding the leash material. Lock 125 may have a position where the lock is engaged with the spool or not engaged with the spool. When the lock is engaged, the spool is locked to prevent more leash from being taken off the spool. When the lock is not engaged, the spool is allowed to spin freely inside housing 105 to pay out leash and retrieve the leash. In one embodiment, the leash may be a rope like material, a webbing, like material, or any other cordage suitable for connecting to a living being. The spool may be spring loaded to allow the spool to automatically retrieve line when lock 125 is not engaged with the spool. The spool may spin in a counterclockwise direction to facilitate the lock interacting with the spool while also using the strength of the back wall of housing 105 to resist pressure exerted by, for example, a dog pulling on a leash when lock 125 is engaged. Housing 105 may further include a leash opening 130 which allows the leash to extend out of housing 105 from the spool.

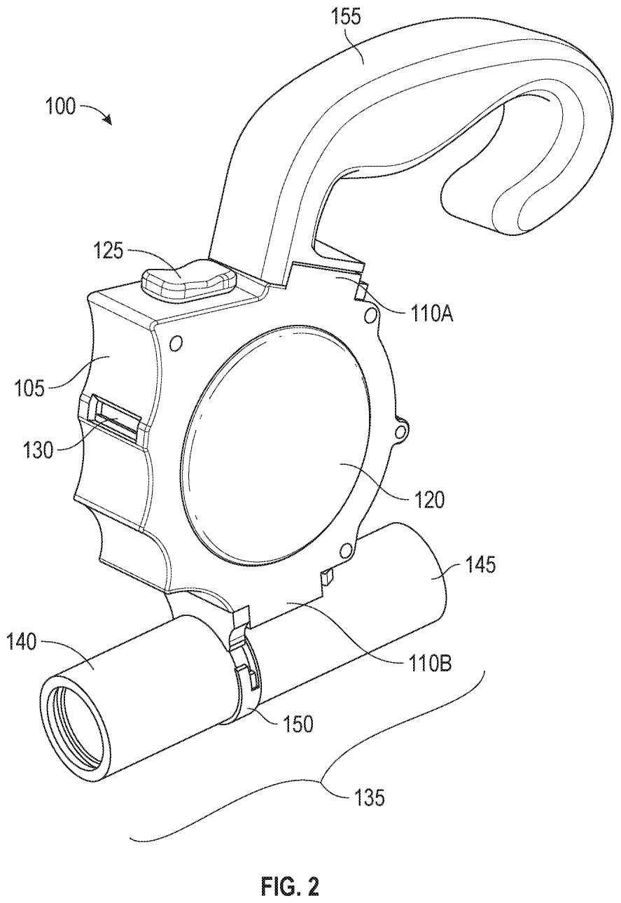

FIG. 2 illustrates a perspective view of a leash body 100 with connected accessories, such as a handle 155, a container 135, a flashlight holder 140, and a waste bag receptacle 145.

As shown in FIG. 2, leash body 100 may be similarly implemented to leash body 100, shown in FIG. 1. For example, leash body 100 may include a housing 105 which may be constructed using various materials including metals, metal alloys, and plastics. Housing 105 may include a number of other elements to provide leash body 100. For example, housing 105 includes a connector 110A which connects to a handle 155. Handle 155 may include a corresponding connection element which interfaces with connector 110A. For example, connector 110A includes a first connection element 115A and a second connection element 115 which may facilitate connection of housing 105 with handle 155. Handle 155 may include a corresponding connection element that may be formed in a shape that is complimentary to connector 110A.

Connector 110B may be similarly implemented to connect to container 135. For example, connector 110B connects to container 135 on housing 105. Container 135 may include a corresponding connection element which interfaces with connector 110B (or 110A as connector 110B and connector 110A are similarly implemented). For example, connector 110B includes connection elements which facilitate connection of housing 105 with container 135. Container 135 may further include a corresponding connection element that may be formed in a shape that is complimentary to connector 110B. Other accessories may be connected to housing 105 by connector 110A or 110B or one or more other connectors that may be implemented in housing 105.

Housing 105 may further include a disc 120. Disc 120 may be responsive to magnetic forces and formed using metals, metal alloys, and other magnetic materials. In one embodiment, disc 120 may be constructed from stainless steel or iron. Disc 120 may have magnetically reactive properties or may itself be implemented as a magnet. Disc 120 may be inserted into a corresponding retainer or molding in housing 105 or may be secured by adhesives such as epoxies and glue. Disc 120 may be installed on a side of housing 105 or both sides of housing 105 to accommodate individuals who are right or left handed, as will be discussed below. It is also noted that disc 120 is shown as being circular, although disc 120 could also be implemented in any geometric shape, such as a triangle, a square, a rectangle, or any other multi-sided shape. The term “disc” in disc 120 is not intended to be limited to meaning a circular shape.

Housing 105 may further include a lock 125 which may be selectively articulated to cause a leash to be locked or released from an internal spool holding the leash material. Lock 125 may have a position where the lock is engaged with the spool or not engaged with the spool. When the lock is engaged, the spool is locked to prevent more leash from being taken off the spool. When the lock is not engaged, the spool is allowed to spin freely inside housing 105 to pay out leash and retrieve the leash.

Container 135 may include two separate elements, such as a flashlight holder 140 and a waste bag receptacle 145 as accessories available for use with leash body 100. As shown in FIG. 2, container 135 includes a connector 150 which allows flashlight holder 140 to connect to waste bag receptacle 145. As shown, waste bag receptacle 145 is connected by connector 110B to housing 105, although this configuration is shown purely for exemplary purposes. Any number of accessories may be connected to other accessories and to housing 105.

Flashlight holder 140 allows a user to insert a flashlight for walking at night with a pet, for example. Flashlight holder 140 may be sized to accept a particular size of flashlight or may be adaptable to different sizes of flashlights. Flashlight holder 140 may be cylindrical in shape with an open barrel, like a tube, which accepts a rear end of a flashlight. Flashlight holder 140 may further be deep enough to prevent a flashlight from falling out without intentionally removal by a user.

Waste bag receptacle 145 may also be formed as a cylinder having an opening to allow a user to both insert a waste bag into waste bag receptacle 145 and remove a waste bag from the waste bag receptacle. Waste bag receptacle 145 may retain a plurality of waste bags to facilitate use with a single dog or a plurality of dogs. Waste bags may be used to collect fecal material from the ground after a dog has defecated. The waste bags may be connected by a knot to handle 155 or container 135, as desired to prevent a user from having to use a second hand to carry the waste bag.

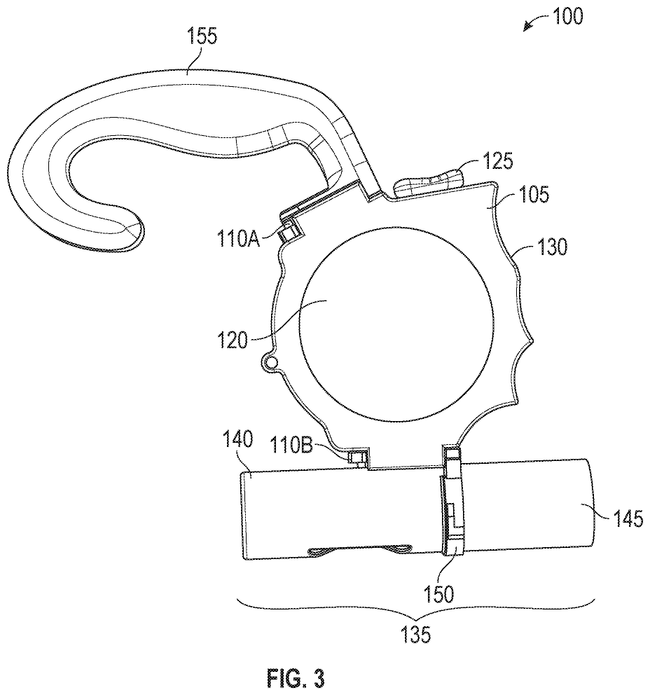

FIG. 3 illustrates a side view of leash body 100 with connected accessories, such as a handle 155, a container 135, a flashlight holder 140, and a waste bag receptacle 145.

As shown in FIG. 3, leash body 100 may be similarly implemented to leash body 100, shown in FIG. 1 and FIG. 2. For example, leash body 100 may include a housing 105 which may be constructed using various materials including metals, metal alloys, and plastics. Housing 105 may include a number of other elements to provide leash body 100. For example, housing 105 includes a connector 110A which connects to a handle 155. Handle 155 may include a corresponding connection element which interfaces with connector 110A. For example, connector 110A includes a first connection element 115A and a second connection element 115 which may facilitate connection of housing 105 with handle 155. Handle 155 may include a corresponding connection element that may be formed in a shape that is complimentary to connector 110A. It is noted that housing 105 may further be fashioned with a plurality of finger slots, which may facilitate use of gloved hand with housing 105 and disc 120, as will be discussed below.

Connector 110B may be similarly implemented to connect to container 135. For example, connector 110B connects to container 135 on housing 105. Container 135 may include a corresponding connection element which interfaces with connector 110B (or 110A as connector 110B and connector 110A are similarly implemented). For example, connector 110B includes connection elements which facilitate connection of housing 105 with container 135. Container 135 may further include a corresponding connection element that may be formed in a shape that is complimentary to connector 110B. Other accessories may be connected to housing 105 by connector 110A or 110B or one or more other connectors that may be implemented in housing 105.

Housing 105 may further include a disc 120. Disc 120 may be responsive to magnetic forces and formed using metals, metal alloys, and other magnetic materials. In one embodiment, disc 120 may be constructed from stainless steel or iron. Disc 120 may have magnetically reactive properties or may itself be implemented as a magnet. Disc 120 may be inserted into a corresponding retainer or molding in housing 105 or may be secured by adhesives such as epoxies and glue. Disc 120 may be installed on a side of housing 105 or both sides of housing 105 to accommodate individuals who are right or left handed, as will be discussed below. It is also noted that disc 120 is shown as being circular, although disc 120 could also be implemented in any geometric shape, such as a triangle, a square, a rectangle, or any other multi-sided shape. The term “disc” in disc 120 is not intended to be limited to meaning a circular shape.

Housing 105 may further include a lock 125 which may be selectively articulated to cause a leash to be locked or released from an internal spool holding the leash material. Lock 125 may have a position where the lock is engaged with the spool or not engaged with the spool. When the lock is engaged, the spool is locked to prevent more leash from being taken off the spool. When the lock is not engaged, the spool is allowed to spin freely inside housing 105 to pay out leash and retrieve the leash.

Container 135 may include two separate elements, such as a flashlight holder 140 and a waste bag receptacle 145 as accessories available for use with leash body 100. As shown in FIG. 2, container 135 includes a connector 150 which allows flashlight holder 140 to connect to waste bag receptacle 145. As shown, waste bag receptacle 145 is connected by connector 110B to housing 105, although this configuration is shown purely for exemplary purposes. Any number of accessories may be connected to other accessories and to housing 105.

Flashlight holder 140 allows a user to insert a flashlight for walking at night with a pet, for example. Flashlight holder 140 may be sized to accept a particular size of flashlight or may be adaptable to different sizes of flashlights. Flashlight holder 140 may be cylindrical in shape with an open barrel, like a tube, which accepts a rear end of a flashlight. Flashlight holder 140 may further be deep enough to prevent a flashlight from falling out without intentionally removal by a user.

Waste bag receptacle 145 may also be formed as a cylinder having an opening to allow a user to both insert a waste bag into waste bag receptacle 145 and remove a waste bag from the waste bag receptacle. Waste bag receptacle 145 may retain a plurality of waste bags to facilitate use with a single dog or a plurality of dogs. Waste bags may be used to collect fecal material from the ground after a dog has defecated. The waste bags may be connected by a knot to handle 155 or container 135, as desired to prevent a user from having to use a second hand to carry the waste bag.

Connector 150 may allow container 135 to connect together in two pieces. For example, connector 150 may include a pin and groove mechanism that may facilitate connection when a pin is rotated into a groove. Connector 150 may further rely on a friction fit, a screw fit, or another connection mechanism for connecting flashlight holder 140 to waste bag receptacle 145. Other types of connectors known in the art may be implemented for connecting accessories to other accessories.

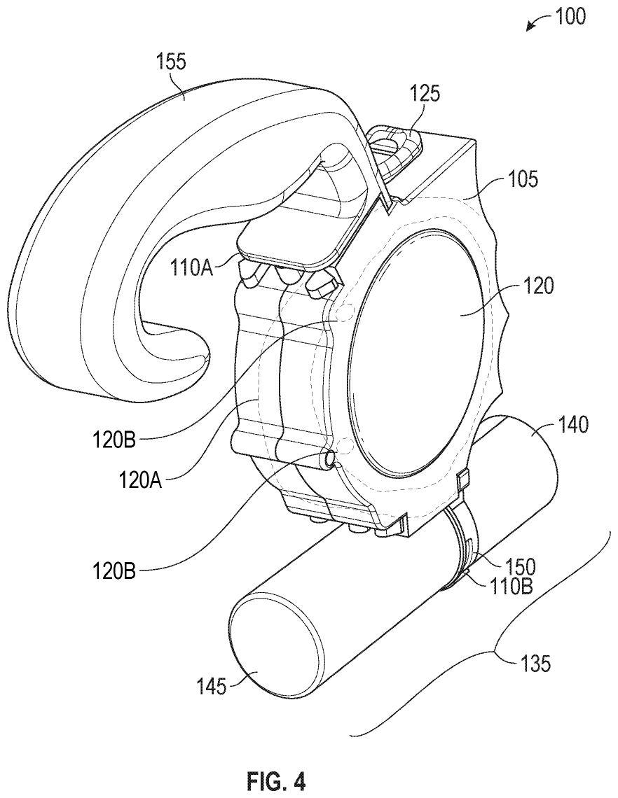

FIG. 4 illustrates a rear perspective view of a leash body 100 with connected accessories such as a handle 155, a container 135, a flashlight holder 140, and a waste bag receptacle 145.

As shown in FIG. 4, leash body 100 may be similarly implemented to leash body 100, shown in FIG. 1, FIG. 2, and FIG. 3. For example, leash body 100 may include a housing 105 which may be constructed using various materials including metals, metal alloys, and plastics. Housing 105 may include a number of other elements to provide leash body 100. For example, housing 105 includes a connector 110A which connects to a handle 155. Handle 155 may include a corresponding connection element which interfaces with connector 110A. For example, connector 110A includes a first connection element 115A and a second connection element 115 which may facilitate connection of housing 105 with handle 155. Handle 155 may include a corresponding connection element that may be formed in a shape that is complimentary to connector 110A. It is noted that housing 105 may further be fashioned with a plurality of finger slots, which may facilitate use of gloved hand with housing 105 and disc 120, as will be discussed below.

Connector 110B may be similarly implemented to connect to container 135. For example, connector 110B connects to container 135 on housing 105. Container 135 may include a corresponding connection element which interfaces with connector 110B (or 110A as connector 110B and connector 110A are similarly implemented). For example, connector 110B includes connection elements which facilitate connection of housing 105 with container 135. Container 135 may further include a corresponding connection element that may be formed in a shape that is complimentary to connector 110B. Other accessories may be connected to housing 105 by connector 110A or 110B or one or more other connectors that may be implemented in housing 105.

Connector 110A and/or connector 110B may be unidirectional or bidirectional in terms of attaching accessories to housing 105. For example, as shown in FIG. 4, handle 155 is connected to housing 105 by connector 110A in a direction that pulls handle 155 into connector 110A when pressure is housing 105 from a leash connected to a pet. In this case, connector 110A, in combination with a connector on handle 155, is unidirectional in that connection can only be effected in one direction. On the other hand, container 135 may be connected to housing 105 by connector 110B which may be bi-directional in that connector 110B may connect to container 135 in either direction (e.g., from the front or the back of connector 110B). Various accessories may be implemented as facilitating a unidirectional or bidirectional attachment.

Housing 105 may further include a disc 120. Disc 120 may be responsive to magnetic forces and formed using metals, metal alloys, and other magnetic materials. In one embodiment, disc 120 may be constructed from stainless steel or iron. Disc 120 may have magnetically reactive properties or may itself be implemented as a magnet. Disc 120 may be inserted into a corresponding retainer or molding in housing 105 or may be secured by adhesives such as epoxies and glue. Disc 120 may be installed on a side of housing 105 or both sides of housing 105 to accommodate individuals who are right or left handed, as will be discussed below. It is also noted that disc 120 is shown as being circular, although disc 120 could also be implemented in any geometric shape, such as a triangle, a square, a rectangle, a ring or any other multi-sided shape. The term “disc” in disc 120 is not intended to be limited to meaning a circular shape.

Housing 105 may further include a lock 125 which may be selectively articulated to cause a leash to be locked or released from an internal spool holding the leash material. Lock 125 may have a position where the lock is engaged with the spool or not engaged with the spool. When the lock is engaged, the spool is locked to prevent more leash from being taken off the spool. When the lock is not engaged, the spool is allowed to spin freely inside housing 105 to pay out leash and retrieve the leash. The spool 120A may also be fitted with magnets 120B which interact with disc 120 to slow the speed of the spool while spinning, according to Lenz's law.

Container 135 may include two separate elements, such as a flashlight holder 140 and a waste bag receptacle 145 as accessories available for use with leash body 100. As shown in FIG. 2, container 135 includes a connector 150 which allows flashlight holder 140 to connect to waste bag receptacle 145. As shown, waste bag receptacle 145 is connected by connector 110B to housing 105, although this configuration is shown purely for exemplary purposes. Any number of accessories may be connected to other accessories and to housing 105.

Flashlight holder 140 allows a user to insert a flashlight for walking at night with a pet, for example. Flashlight holder 140 may be sized to accept a particular size of flashlight or may be adaptable to different sizes of flashlights. Flashlight holder 140 may be cylindrical in shape with an open barrel, like a tube, which accepts a rear end of a flashlight. Flashlight holder 140 may further be deep enough to prevent a flashlight from falling out without intentionally removal by a user.

Waste bag receptacle 145 may also be formed as a cylinder having an opening to allow a user to both insert a waste bag into waste bag receptacle 145 and remove a waste bag from the waste bag receptacle. Waste bag receptacle 145 may retain a plurality of waste bags to facilitate use with a single dog or a plurality of dogs. Waste bags may be used to collect fecal material from the ground after a dog has defecated. The waste bags may be connected by a knot to handle 155 or container 135, as desired to prevent a user from having to use a second hand to carry the waste bag.

Connector 150 may allow container 135 to connect together in two pieces. For example, connector 150 may include a pin and groove mechanism that may facilitate connection when a pin is rotated into a groove. Connector 150 may further rely on a friction fit, a screw fit, or another connection mechanism for connecting flashlight holder 140 to waste bag receptacle 145. Other types of connectors known in the art may be implemented for connecting accessories to other accessories.

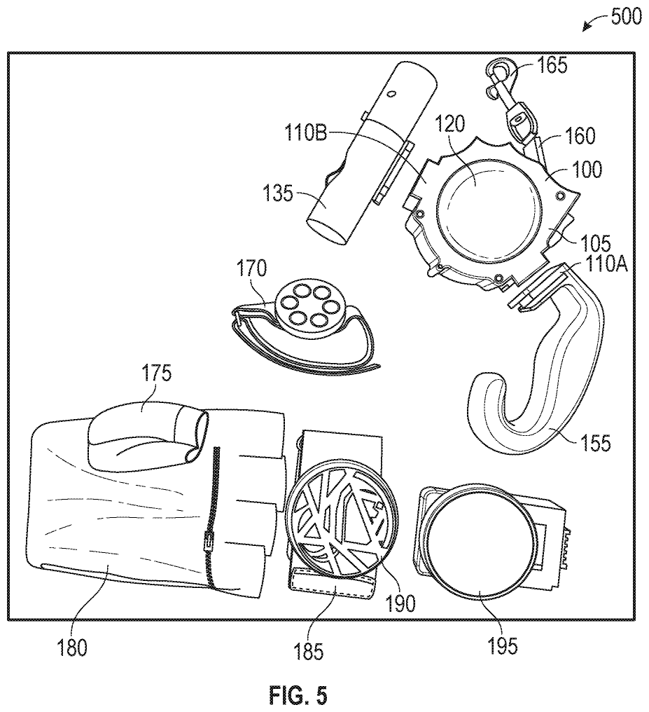

FIG. 5 illustrates a leash system 500. Leash system 500 includes a plurality of devices which facilitate leash system 500. For example, leash system 500 includes leash body 100, shown in FIGS. 1-4 and described herein with respect to FIGS. 1-4. Leash body 100 further includes a housing 105, one or more connector 110A and 110B. Leash body 100 further includes disc 120 which facilitates magnetic connection with other devices in leash system 500, as will be described below. Leash body 100 further includes a leash 160 and a leash connector 165.

As previously discussed, various accessories may be included in leash system 500, which may also connect to one or more connectors 110A and 110B. Accessories such as handle 155 and container 135 may be included in leash system 500 according to a user's desires. Accessories such as handle 155 and container 135 may provide the user with solutions to carry items necessary to walk a pet, while also facilitating modular flexibility for which accessories a user deems appropriate or necessary for a particular situation.

System 500 may further include a hand strap, such as hand strap 170 which may include a magnet disposed on hand strap 170 with hook and loop tape that may be secured around a hand of a user (e.g., behind the fingers of the hand but in front of the thumb of the hand). Hand strap 170 may also be an elastic strap. Magnetic connector 170 may magnetically connect to disc 120 of leash body 100 with enough force to ensure connection under the pressure created by the strongest of pets. In this manner, the user is free to use both hands, while ensuring that leash body 100 is securely connected to the user.

System 500 may further include a glove 175 which includes a magnet 180. Glove 175 may include a pocket which contains a magnet that may magnetically connect to disc 120 of leash body 100 with enough force to ensure connection under the pressure created by the strongest of pets. Glove 175 may be fitted on the hand of the user and provide a pocket on the palm or the back of the hand on the glove to retain magnet 180. The pocket may be sealed to ensure that magnet 180 cannot be pulled out of the pocket of glove 175 when magnet 180 is connected to disc 120.

System 500 may further include a wrist strap 185 which includes a magnet 190. Wrist strap 185 may be a strap connected by hook and loop tape or may be an elastic strap. Wrist strap 185 may connect to the wrist of a user and be secured by elastic tension or by hook and loop tape connected to wrist strap 185. Magnet 190 may magnetically connect to disc 120 of leash body 100 with enough force to ensure connection under the pressure created by the strongest of pets.

System 500 may further include a buckle strap 195 that includes a magnet. Buckle strap 195 may be a strap connected by a buckle to a user via a wrist, arm, or leg. Buckle strap 195 may be secured by a buckle or may also use elastic tension or by hook and loop tape. Buckle strap 195 may further use the included magnet to magnetically connect to disc 120 of leash body 100 with enough force to ensure connection under the pressure created by the strongest of pets.

Hand strap 170, glove 175, wrist strap 185, and buckle strap 195 may be used to allow a user to have access to both hands during an excursion with a pet. Hand strap 170, glove 175, wrist strap 185, and buckle strap 195 provide for a hands-free walking experience in a modular fashion by allowing the user to connect the desired accessories according to the user's perceived desires and necessities for a particular pet excursion.

Other accessories may be included in leash system 500. For example, leash system 500 may include a pet food dispenser accessory, a pet water bowl accessory, a pet tracking system accessory, a pet ball accessory, a pet toy accessory, a wireless phone accessory, a power bank accessory, a personal belongings accessory (e.g., an accessory for holding rings, necklaces, jewelry, keys, wallets, and etc.), a makeup container accessory, accessories to connect to multiple pets, pet waste bags that glow in the dark and include an arrow in the direction of opening, and the like.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A pet leash, comprising:
a housing, the housing comprising:
a first connector disposed in the housing
a leash opening from which a leash is released from a spool internal to the housing.

2. The pet leash of claim 1, further comprising a second connector disposed in the housing.

3. The pet leash of claim 2, wherein the first connector disposed in the housing and the second connector disposed in the housing include a connection element.

4. The pet leash of claim 3, wherein the first connector disposed in the housing includes a retainer which secures a connection between the first connector disposed in the housing to a handle.

5. The pet leash of claim 3, wherein the second connector disposed in the housing includes a retainer which secures a connection between the first connector disposed in the housing to an accessory device.

6. The pet leash of claim 1, further comprising a magnetic disc disposed in the housing.

7. The pet leash of claim 6, wherein the disc disposed in the housing is disposed on a side of the housing and open to an outside of the housing.

8. The pet leash of claim 6, wherein the spool disposed inside the housing includes one or more magnets which interact with the disc disposed in the housing.

9. The pet leash of claim 1, further comprising a lock which interacts with the spool to stop the spool from releasing leash line through the leash opening.

10. A pet leash system, comprising:
a housing, the housing comprising:
one or more connectors disposed in the housing
a leash opening from which a leash is released from a spool internal to the housing;
a handle connectible to the one or more connectors and removable from the one or more connectors.

11. The pet leash system of claim 10, wherein the handle is connectible to the one or more connectors by a connection element.

12. The pet leash system of claim 11, wherein the connection element includes a retainer for the handle.

13. The pet leash system of claim 10, further comprising an accessory hand strap which includes a magnet and connects to a user around the user's hand.

14. The pet leash system of claim 10, further comprising an accessory glove which includes a magnet and connects to a user by the user's hand.

15. The pet leash system of claim 10, further comprising an accessory wrist strap which includes a magnet and connects to the user around the user's wrist.

16. The pet leash system of claim 10, further comprising an accessory buckle strap which includes a magnet and which connects to a magnetic disc disposed in the housing.

17. The pet leash system of claim 10, further comprising a magnetic disc disposed on the housing.

18. The pet leash system of claim 17, wherein the disc disposed in the housing is disposed on a side of the housing and open to an outside of the housing.

19. The pet leash system of claim 11, wherein the spool disposed inside the housing includes one or more magnets which interact with the disc disposed in the housing.

20. The pet leash of claim 11, further comprising a lock which interacts with the spool to stop the spool from releasing leash line through the leash opening.
